(19) United States
(12) Patent Application Publication
(10) Pub. No.: US 2011/0037783 A1
(43) Pub. Date: Feb. 17, 2011

(54) BACKLIGHT UNIT AND DISPLAY APPARATUS INCLUDING THE SAME

(76) Inventors: Hoon HUR, Pyeongtaek-si (KR); Bup Sung Jung, Pyeongtaek-si (KR)

Correspondence Address: KED & ASSOCIATES, LLP, P.O. Box 8638, Reston, VA, 20195, US

(21) Appl. No.: 12/728,111

(22) Filed: Mar. 19, 2010

Related U.S. Application Data
(60) Provisional application No. 61/233,890, filed on Aug. 14, 2009.

(30) Foreign Application Priority Data
Aug. 14, 2009 (KR) 10-2009-0075120

(51) Int. Cl. G09G 5/10; G02F 1/13357

(52) U.S. Cl. 345/690; 362/97.1

(57) ABSTRACT

A backlight unit includes a plurality of light sources emitting light in a first direction with a predetermined orientation angle and a plurality of light guide panels, each including a light incident section and a light emitting section. The light incident section has a first surface to receive light emitted from one or more of the light sources in the first direction, and the light emitting section is to emit light received from the light incident section in a second direction. Also included is a reflecting member adjacent the light guide panels. The light emitting section of each light guide panel includes a portion that decreases in thickness from a first point to a second point, wherein the first point is closer to the light incident section and the second point.

### CROSS-REFERENCE TO RELATED APPLICATIONS

The present application claims priority under 35 U.S.C. §119 and 35 U.S.C. §365 to U.S. Provisional Patent Application Ser. No. 61/233,890 filed on Aug. 14, 2009 and Korean Patent Application No. 10-2009-0075120, filed on Aug. 14, 2009, which is hereby incorporated by reference in its entirety.

### BACKGROUND

1. Field

One or more embodiments disclosed herein relate to illumination systems.

2. Background

As our information society develops, needs for diverse forms of display apparatuses are increasing. Accordingly, research has been carried out on various display apparatuses such as liquid crystal display devices (LCDs), plasma display panels (PDPs), electro luminescent displays (ELDs), and vacuum fluorescent displays (VFDs), which have been commercialized.

Of these, an LCD has a liquid crystal panel that includes a liquid crystal layer, a thin film transistor (TFT) substrate, and a color filter substrate facing the TFT substrate with the liquid crystal layer therebetween. Such a liquid crystal panel, having no light source, uses light provided by a backlight unit to display an image.

### BRIEF DESCRIPTION OF THE DRAWINGS

FIG. 1 is a diagram showing one embodiment of a display apparatus.

FIG. 2 is a diagram showing a cross-sectional view of a display module which, for example, may be included in the display apparatus of FIG. 1.

FIG. 3 is a diagram showing one embodiment of a backlight unit that may be included in the display apparatus of FIG. 1.

FIG. 4 is a block diagram corresponding to the display apparatus of FIG. 1

FIG. 5 is a diagram showing another embodiment of a backlight unit.

FIG. 6 is a diagram showing an optical assembly which may be included in the backlight unit of FIG. 5.

FIG. 7 is a diagram showing a reflecting member that may be included in one or more of the aforementioned embodiments of the backlight unit.

FIG. 8 is a diagram showing a cross-sectional view along line B-B in FIG. 5.

FIG. 9 is a diagram showing a light guide panel that may correspond to FIG. 8.

FIG. 10 is a diagram showing another view of an optical assembly.

FIG. 11 is a diagram showing a cross-sectional view along line C-C of FIG. 10.

FIG. 12 is a diagram showing a light guide panel and light sources in accordance with one or more embodiments described herein.

FIG. 13 is a diagram showing an example of portion C in FIG. 12.

FIG. 14 is a diagram showing a cross-sectional view along line D-D of FIG. 1.

FIG. 15 is a diagram showing another embodiment of a backlight unit.

FIG. 16 is a diagram showing another embodiment of a backlight unit.

FIG. 17 shows controlling elements for a display apparatus according to an embodiment.

FIG. 18 shows controlling elements for a back light unit according to an embodiment.

FIG. 19 is a perspective view illustrating a reflecting element and a substrate according to an embodiment.

FIG. 20 is a perspective view illustrating a backlight unit according to an embodiment.

FIG. 21 is a plan view of a rear surface of a bottom cover of FIG. 20.

FIG. 22 is a perspective view of a substrate according to an embodiment.

FIG. 23 is a perspective view of a rear surface of the substrate of FIG. 22.

FIG. 24 is an exploded perspective view of an optical assembly according to an embodiment.

FIG. 25 is a perspective view of two light guide panels that are aligned of FIG. 24.

### DETAILED DESCRIPTION

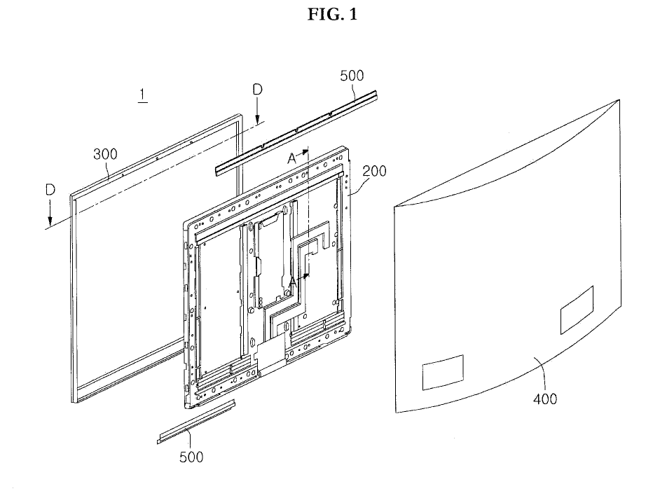

FIG. 1 is an exploded perspective view illustrating a display apparatus 1 according to an embodiment. Referring to FIG. 1, the display apparatus 1 includes a display module 200, a front cover 300 and a back cover 400 that surround the display module 200, and a fixing member 500 for fixing the display module 200 to at least one of the front cover 300 and the back cover 400.

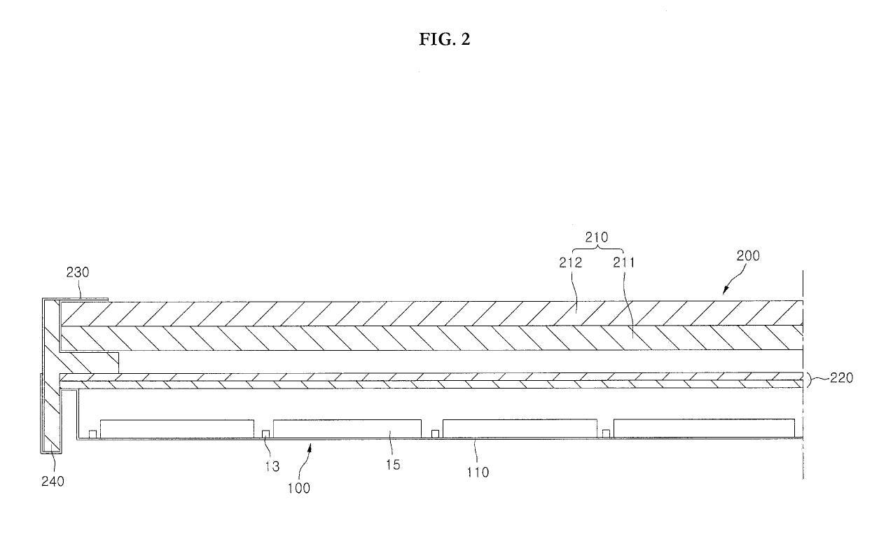

The front cover 300 may include a transparent front panel (not shown) for transmitting light. The front panel is spaced a predetermined distance from the display module 200, and more particularly, from the front surface of a display panel 210 (refer to FIG. 2) of the display module 200 to protect the display module 200 from external shock and transmit light emitted from the display module 200, so that an image generated from the display module 200 can be displayed to the outside.

A portion of the fixing member 500 is fixed to the front cover 300 through a coupling member such as a screw, and then, another portion of the fixing member 500 supports the display module 200 with respect to the front cover 300, so that the display module 200 can be fixed with respect to the front cover 300.

Although the fixing member 500 has an elongated plate shape in the current embodiment, the display module 200 may be fixed to the front cover 300 or the back cover 400 through a coupling member without the fixing member 500.

FIG. 2 is a cross-sectional view taken along line A-A of FIG. 1. Referring to FIG. 2, the display module 200 includes the display panel 210 for displaying an image, a backlight unit 100 emitting light to the display panel 210, a bottom cover 110 providing the lower appearance of the display module 200, a panel supporter 240 supporting the display panel 210 from the lower side, a top cover 230 supporting the display panel 210 from the upper side and constituting a border of the display module 200.

The bottom cover 110 may have a box shape with an open upper surface to receive the backlight unit 100. A side of the bottom cover 110 may be fixed to a side of the top cover 230. For example, a coupling member such as a screw may pass through a side surface of the display module 200, that is, through a side where the bottom cover 110 overlaps the top cover 230 to fix the bottom cover 110 and the top cover 230.

For example, the display panel 210 may include a lower substrate 211 and an upper substrate 212 attached to each other with a constant cell gap, and a liquid crystal layer interposed between the lower substrate 211 and the upper substrate 212. The lower substrate 211 is provided with a plurality of gate lines and a plurality of data lines crossing the gate lines. Thin film transistors (TFTs) may be disposed in crossing areas of the gate lines and the data lines.

The upper substrate 212 may be provided with color filters, but the structure of the display panel 210 is not limited thereto. For example, the lower substrate 211 may include color filters as well as TFTs. In addition, the structure of the display panel 210 may be varied according to a method of driving the liquid crystal layer.

Although not shown, an edge of the display panel 210 may be provided with a gate driving printed circuit board (PCB) supplying scan signals to the gate lines, and a data driving PCB supplying data signals to the data lines. One of the upper and lower sides of the display panel 210 may be provided with a polarized light filter (not shown).

An optical sheet 220 may be disposed between the display panel 210 and the backlight unit 100, or the optical sheet 220 may be removed, and thus the present disclosure is not limited thereto. The optical sheet 220 may include at least one of a spread sheet (not shown) and a prism sheet (not shown).

The spread sheet uniformly spreads light emitted from a light guide panel, and the spread light may be collected to the display panel 210 through the prism sheet. The prism sheet including one or more illumination enhancement films and at least one of a horizontal prism sheet and a vertical prism sheet may be selectively provided. The types and number of optical sheets may be varied within the scope of the present disclosure.

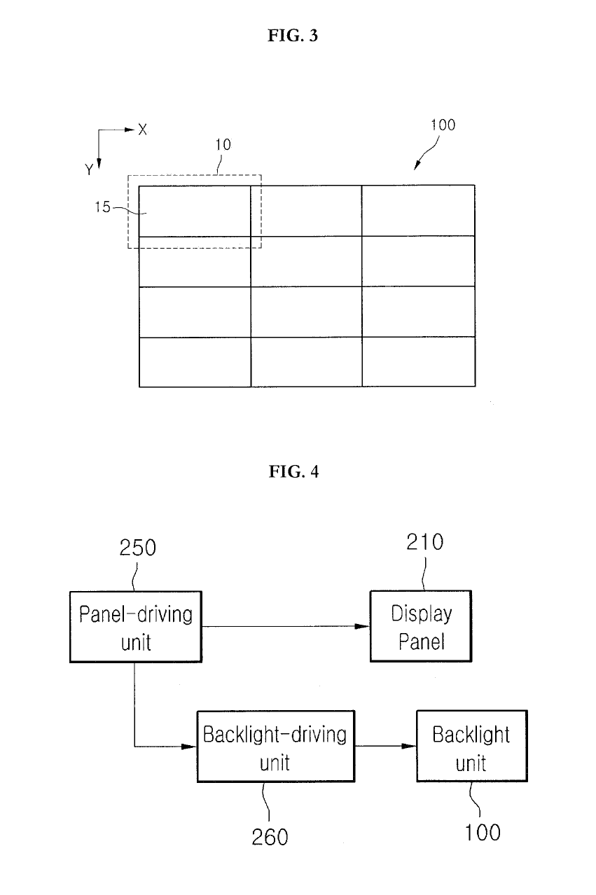

The backlight unit 100 may include a plurality of optical assemblies 10 (refer to FIG. 3), each of which may include a light source 13 and a light guide panel 15. The light source 13 is disposed on a side of the light guide panel 15 to emit light to the side of the light guide panel 15. For example, the light source 13 may emit light with a predetermined orientation angle with respect to a specific direction in which a light emitting surface of the light source 13 is oriented.

According to the current embodiment, the light source 13 may include one or more light emitting diodes (LEDs). For example, the light source 13 including an LED may emit light with a predetermined orientation angle of about 120° with respect to a direction in which the light emitting surface is oriented.

The LED may be a side illumination-type LED, and be a color LED emitting at least one of red, blue, and green light, or a white LED. The color LED may include at least one of a red LED, a blue LED, and a green LED, and the arrangement and light type of the LEDs may be varied within the scope of the present disclosure.

The light guide panel 15 may be transparent. For example, the light guide panel 15 may be formed of one of acryl-based resin such as polymethyl metaacrylate (PMMA), polyethylene terephthlate (PET), poly carbonate (PC), and polyethylene naphthalate (PEN). The light guide panel 15 may be formed using an extrusion molding method.

The light guide panel 15 may refract and diffuse light, laterally emitted from the light source 13, in the upper direction, that is, to the display panel 210. A reflecting member (not shown) may be disposed under the light guide panel 15.

The light source 13 and the light guide panel 15 are illustrated in FIG. 2 on the basis of their functions, but the shape, coupling structure and relative position of the light source 13 and the light guide panel 15 may be varied within the scope of the present disclosure.

For example, the adjacent light guide panels 15 may partially overlap each other, and decrease in thickness in a predetermined direction.

The backlight unit 100 may be divided into a plurality of blocks, and dividedly driven in a block unit. That is, a plurality of blocks constituting the backlight unit 100 respectively emit streaks of light having different brightness from each other. To this end, the blocks independently receive driving voltages and operate.

For example, the display panel 210 may have a plurality of division areas. The intensity of light emitted from a block of the backlight unit 100, that is, the brightness of the corresponding light source is adjusted according to a gray peak value or a color coordinate signal of the corresponding division area, so as to adjust the brightness of the display panel 210.

FIG. 3 is a plan view illustrating the front side of the backlight unit 100. Referring to FIG. 3, the optical assemblies 10 of the backlight unit 100 may be arrayed in an N×M matrix (N is the number of rows arrayed along a y-axis direction, M is the number of columns arrayed along an x-axis direction, and M and N are natural numbers equal to 2 or greater). Each of the optical assemblies 10 may include the light source 13 and the light guide panel 15.

The light source 13 may emit light with a predetermined orientation angle, e.g. with an orientation angle of about 120° with respect to a first direction (denoted by an arrow), that is, with respect to a parallel direction to a y-axis. Light emitted from the light source 13 is laterally incident to the lower end of the light guide panel 15 and then may travel to the upper end of the light guide panel 15.

The backlight unit 100 may include the light guide panels 15 in the N rows arrayed in the first direction in which the light is emitted, that is, in the y-axis direction, and the light guide panels 15 in the M columns arrayed in a direction crossing the first direction, that is, in the x-axis direction.

That is, as illustrated in FIG. 3, the backlight unit 100 may include the nine light guide panels 15 (M1 to M9) that are the light guide panel 15 in three rows in the first direction and the light guide panels 15 in three columns arrayed in the crossing direction to the first direction.

Each of the optical assemblies 10 is driven in an edge-type backlight manner and operates as a single light source. In this state, the optical assemblies 10 are arrayed in a direct-type backlight manner to constitute the backlight unit 100. Thus, the case that the LEDs are detected as a hot spot on a screen can be prevented, and the thickness of the light guide panel 15 and the number of optical films can be reduced to achieve the slimness of the backlight unit 100.

For example, the backlight unit 100 may include the twelve optical assemblies 10 in a 4×3 matrix as illustrated in FIG. 3, but the present disclosure is not limited thereto. Thus, the matrix of the optical assemblies 10 can be varied according to a screen size of a display apparatus.

Each of the optical assemblies 10 may be manufactured as a discrete assembly, and the optical assemblies 10 may be adjacent to each other to constitute a module-type backlight unit that is a backlight member configured to provide light to the display panel 210.

The backlight unit 100 may be driven using an entire driving method or a local driving method such as a local dimming method and an impulsive method. The method of driving the LEDs may be varied according to a circuit design, and thus is not limited. According to the embodiment, a color contrast ratio is increased, and a bright region and a dark region can be sharply expressed on a screen, thereby improving image quality.

That is, the backlight unit 100 is operated by a plurality of division driving areas corresponding to the light guide panels 15, and the brightness of the division driving area is linked with brightness corresponding to an image signal. Thus, the brightness in a dark portion of an image is decreased, and the brightness in a bright portion of the image is increased, so as to improve a contrast ratio and sharpness of the image.

For example, a portion of the optical assemblies 10 is independently driven to emit light. To this end, the light sources 13 respectively of the optical assemblies 10 may be independently controlled.

An area of the display panel 210 corresponding to one of the optical assemblies 10 or one of the light guide panels 15 may be divided into two or more blocks, and the display panel 210 and the backlight unit 100 may be dividedly driven in a block unit.

The light sources 13 are disposed on the lower side of the light guide panel 15 on the basis of FIG. 3, but the present disclosure is not limited thereto. For example, the light sources 13 may be disposed on the upper side, left side or right side of the light guide panel 15.

According to the embodiment, the backlight unit 100 employs the local driving method to reduce power consumption, thus reducing costs.

In addition, a process of assembling the optical assemblies 10 to manufacture the backlight unit 100 is simple, and losses generated during the assembling process are minimized, thus improving productivity. Furthermore, the light guide panel 15 can be prevented from being scratched while the backlight unit is assembled, and optical mura can be prevented, thereby improving process reliability and the quality of the backlight unit 100.

In addition, the optical assemblies 10 are standardized to be adapted for mass production and applied to backlight units having various sizes.

In addition, when one of the optical assemblies 10 is damaged, only the damaged optical assembly 10 can be replaced without replacing the backlight unit 100. Thus, a replacing process is convenient, and a replacing cost is reduced.

In addition, the optical assemblies 10 and the backlight unit 100 including the optical assemblies 10 are resistant to external shock or environmental changes and have high durability.

In addition, since the adjacent optical assemblies 10 overlap each other, a bright line or a dark line generated at the boundary of the optical assemblies 10 is prevented to improve the uniformity of light.

FIG. 4 is a block diagram of a display device that may include the display panel 210, the backlight unit 100, a panel-driving unit 250, and a backlight-driving unit 260.

The display panel 210 has a rectangular shape corresponding to the backlight unit 100 illustrated in FIG. 3. An image signal may be scanned in a frame unit along the extending direction of a short side of the display panel 210 as a scan direction. An image may be displayed on the display panel 210 at 60, 120 or 180 frames per second. As the number of frames per second is increased, a scan period (T) of the frames is decreased.

The panel-driving unit 250 receives various control signals and image signals from the outside to generate a driving signal for driving the display panel 210 and supply the driving signal to the display panel 210. For example, the panel-driving unit 250 may include a gate-driving part (not shown) connected to the gate lines of the display panel 210, a data-driving part (not shown), and a timing controller (not shown) controlling the gate-driving part and the data-driving part.

The panel-driving unit 250 may output image information, corresponding to an image signal, to the backlight-driving unit 260 to control the brightness of light sources of the backlight unit 100 corresponding to the image signal. The panel-driving unit 250 may provide the backlight-driving unit 260 with information about the scan period (T) for displaying a frame on the display panel 210, e.g. with a vertical synchronization signal (V_{sync).}

The backlight-driving unit 260 drives the light sources of the backlight unit 100 according to the scan period (T), so as to control the light sources to emit light in synchronization with a time when an image is displayed on the display panel 210.

Referring to FIG. 3, the backlight unit 100 may include the optical assemblies 10 that respectively include the light sources and that are driven separately. In addition, the optical assemblies 10 may be arrayed in a plurality of lines in matrix form.

The light source of the optical assembly 10 may include a plurality of point light sources such as LEDs. The point light sources may be simultaneously turned on/off. According to another embodiment, the point light sources of the optical assembly 10 may be divided into a plurality of blocks and simultaneously turned on/off in a block unit.

According to the current embodiment, the backlight-driving unit 260 may provide the optical assemblies 10 of the backlight unit 100 with a line control signal that is used to sequentially scan the lines formed by the optical assemblies 10 according to the scan period (T) and a data signal having a brightness value corresponding to image information output from the panel-driving unit 250.

Alternatively, the backlight unit may include the backlight-driving unit 260.

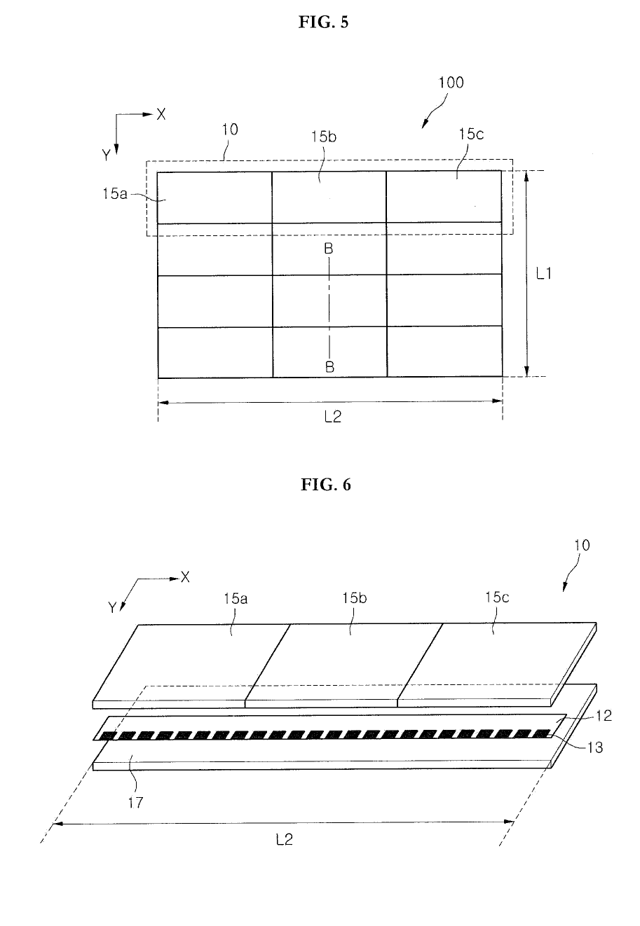

FIG. 5 is a plan view illustrating the backlight unit 100. A description of the same part as those of FIGS. 1 to 4 will be omitted. Referring to FIG. 5, light guide panels in M columns arrayed in the perpendicular direction to the direction in which light is emitted from the light source 13, that is, in the x-axis direction may constitute the optical assembly 10. That is, the backlight unit 100 may include the optical assemblies 10 that may include a plurality of light guide panels 15a, 15b, and 15c arrayed in the x-axis direction.

Referring to FIG. 6, the optical assembly 10 may include the light guide panels 15a-15c, light sources 13, a module substrate 12 to which the light sources 13 are mounted, and a reflecting member 17. M light guide panels arrayed in the perpendicular direction to the direction in which light is emitted from the light source 13, i.e., in the x-axis direction may constitute the optical assembly 10, that is, the light guide panels 15a, 15b, and 15c may be arrayed in the long axis direction of the module substrate 12.

More particularly, the light guide panels 15a, 15b, and 15c may be disposed on the single module substrate 12 and the single reflecting member 17 to constitute the optical assembly 10 that may be provided in plurality to constitute the backlight unit 100.

Since the single optical assembly 10 includes the light guide panels 15a, 15b, and 15c, the number of the optical assemblies 10 constituting the backlight unit 100 can be reduced, thus facilitating an assembling process of the optical assemblies 10 to form the backlight unit 100.

That is, a time required for assembling the optical assemblies 10 to manufacture the backlight unit can be reduced, and a process tolerance generated during the assembling of the optical assemblies can be easily controlled within a predetermined range.

For example, when the optical assembly 10 includes the single light guide panel 15 as illustrated in FIG. 3, the twelve optical assemblies 10 are assembled in matrix form to constitute the backlight unit 100. However, when the optical assembly 10 includes the light guide panels 15a, 15b, and 15c of FIG. 5, the four optical assemblies 10 are assembled along the y-axis direction to constitute the backlight unit 100.

That is, referring to FIG. 5, the four optical assemblies 10 may be adjacent to each other along the y-axis direction, and each of the four optical assemblies 10 may include the light guide panels 15a, 15b, and 15c in the x-axis direction, so as to constitute the backlight unit 100.

As described above, when the optical assemblies 10 each including the single reflecting member 17 are adjacent to each other along the y-axis to constitute backlight unit 100, the length of the reflecting member, that is, the length of the reflecting member extended along the x-axis may be equal to a length L2 of the backlight unit along the x-axis.

As illustrated in FIG. 6, the light sources 13 disposed on the module substrate 12 may be adjacent to the lower ends of the light guide panels 15a, 15b, and 15c, and thus, the y-axis may be parallel to the direction of light emitted from the light sources 13, and the x-axis may be perpendicular to the direction of light emitted from the light sources 13.

The present disclosure is not limited to the embodiment of FIG. 5. That is, the number of the light guide panels 15 or the number of the optical assemblies 10 provided to the backlight unit 100 may be varied.

To form the single optical assembly 10 including the light guide panels 15a, 15b, and 15c, light sources 13, module substrate 12 to which the light sources are mounted, and reflecting member 17, a structure for fixing the light guide panels 15a, 15b, and 15c, the module substrate 12, and the reflecting member 17, e.g. a coupling member may be required.

Although the light guide panels are arrayed in a 4×3 matrix to constitute backlight unit 100 as illustrated in FIGS. 5 and 6, the number of the light guide panels provided to the backlight unit 100 may be increased. As the number of the light guide panels provided to the backlight unit is decreased, the efficiency of the division driving of the backlight unit as described above, such as the local dimming method may be decreased. Accordingly, power consumed for driving the backlight unit 100 may be increased.

Thus, to reduce power consumption by improving a driving efficiency when driving backlight unit 100 using a division driving method such as the local dimming method, the number of light guide panels 15 provided to the backlight unit, and particularly, the number of the light guide panels arrayed in the direction of light emitted from light sources 13, i.e., in a vertical direction (y-axis direction) may be 6 or more, and the number of the light guide panels arrayed in the perpendicular direction to the direction of light emitted from light sources 13, i.e., in a horizontal direction (x-axis direction) may be 4 or more.

However, when the number of the light guide panels 15 provided to the backlight unit 100 is increased, an assembling process of the light guide panels to manufacture the backlight unit may be complicated, and it may be difficult to control a process tolerance within a predetermined range.

In addition, even when the number of the light guide panels 15 provided to the backlight unit 100 is further increased, the division driving efficiency and power consumption of the backlight unit 100 are converged at a constant value.

That is, according to a test result, even when the number of the light guide panels 15 arrayed in the direction of light emitted from the light sources 13, i.e., in the vertical direction (y-axis direction) may be greater than 50, the division driving efficiency and power consumption of the backlight unit 100 may be approximately the same as those of a case where the number of the light guide panels 15 is 50.

Even when the number of the light guide panels 15 arrayed in the perpendicular direction to the direction of light emitted from the light sources 13, i.e., in the horizontal direction (x-axis direction) may be greater than 35, the division driving efficiency and power consumption of the backlight unit 100 may be approximately the same as those of a case where the number of the light guide panels 15 is 35.

Thus, to improve the division driving efficiency and power consumption of the backlight unit 100 and to control a process tolerance by facilitating a process of manufacturing the backlight unit 100, the number of the light guide panels 15 arrayed in the direction of light emitted from the light sources 13, i.e., in the vertical direction (y-axis direction) may range from 6 to 50, and the number of the light guide panels 15 arrayed in the perpendicular direction to the direction of light emitted from the light sources 13, i.e., in the horizontal direction (x-axis direction) may range from 4 to 35.

Thus, according to the embodiment, the 4 to 35 light guide panels 15 may be arrayed on the reflecting member 17 and the module substrate 12 that are extended in the perpendicular direction to the direction of light emitted from the light sources 13, i.e., in the horizontal direction (x-axis direction), so as to constitute the optical assembly 10 in a single line, and then, the 6 to 50 optical assemblies 10, each of which is disposed in a single line as described above, are arrayed in the direction of light emitted from the light sources 13, i.e., in the vertical direction (y-axis direction), so as to constitute the backlight unit 100.

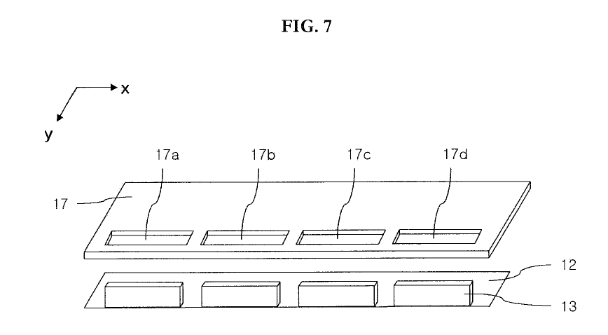

FIG. 7 is a perspective view illustrating the reflecting member 17. Referring to FIG. 7, the module substrate 12 to which the light sources 13 are mounted may be disposed under the reflecting member that may be provided with holes 17a, 17b, 17c, and 17d for receiving the light sources 13 disposed on the module substrate 12.

The light sources 13 may be inserted to the holes 17a, 17b, 17c, and 17d of the reflecting member 17 from the lower side and at least one portion of the light sources 13 may protrude to the upper side of the reflecting member 17. The light sources protruding upward through the holes of the reflecting member emit light that may be laterally incident to the light guide panels 15 disposed on the upper side of the reflecting member.

As such, the structure in which the light sources 13 are inserted into the holes 17a, 17b, 17c, and 17d of the reflecting member 17 constitutes the backlight unit 100, so as to improve a fixing efficiency between the reflecting member 17 and the module substrate 12 to which the light sources 13 are mounted.

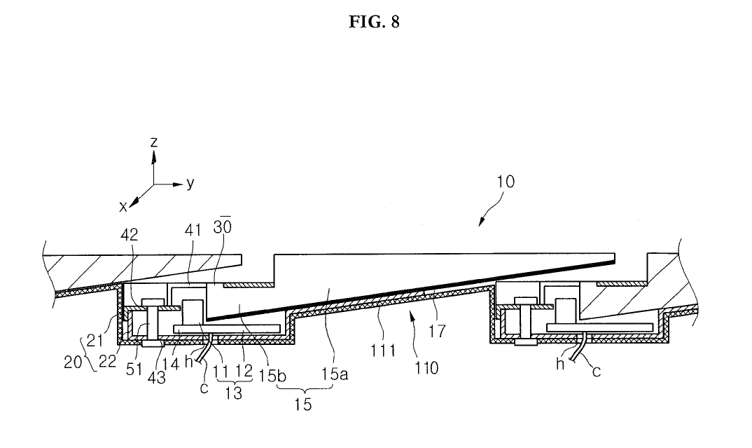

Hereinafter, the optical assembly 10, including the light guide panels 15a, 15b, and 15c fixed to the module substrate 12 and the reflecting member 17, will now be described with reference to FIGS. 8 to 11.

FIG. 8 is a cross-sectional view taken along line B-B of FIG. 5. A description of the same part as those of FIGS. 1 to 6 will be omitted. Referring to FIG. 8, the optical assembly 10 may include light sources 13, light guide panels 15, module substrate 12, and a side cover 20 for fixing the reflecting member 17. The side cover 20 provides a fixing position with respect to the bottom cover 110 and may include a first side cover 21 and a second side cover 22.

That is, the light guide panels 15a-15c arrayed along the x-axis as illustrated in FIG. 6 may be fixed to side cover 20, and the single module substrate 12, the single reflecting member 17, and the light guide panels 15a, 15b, and 15c may be fixed to the side cover 20.

As illustrated in FIG. 8, the light guide panels 15 are fixed to the module substrate 12 and the reflecting member 17 through the side cover 20 to constitute the optical assembly 10, thus facilitating the assembling of the optical assemblies 10 to manufacture the backlight unit 100.

Each of the light guide panels 15 may include a first part 151 and a second part 152. The second part 152 may include an upper surface generating a surface light source, a lower surface facing the upper surface, and four side surfaces.

The first part 151 may horizontally protrude from one of the side surfaces of the second part 152 along the lower portion of the side surface. The first part 151 may be a light incident part having a light incident surface to which light is incident from the light source 13, and the second part 152 may be a light emitting part that emits light, laterally incident through the light incident part, to the upper side, thus substantially providing the light to the display panel 210.

According to the embodiment, the adjacent optical assemblies 10, and particularly, the adjacent two of the light guide panels 15 may overlap each other in a predetermined area.

For example, the light sources 13, the first part 151, i.e., the light incident part, and the side cover 20 are disposed on one side of the optical assembly 10, and the light sources 13, the first part 151, and the side cover 20 may be disposed under the adjacent optical assembly 10, and particularly, under the second part 152 of the adjacent optical assembly 10, that is, under the light emitting part.

That is, when the number of rows of the light guide panels 15 arrayed in the first direction in which light is emitted from the light source 13, i.e., in the first direction is N, at least one portion of the light emitting part of the light guide panel 15 in a K^{th} row (K is one of 1 to N−1) of the N rows may be disposed above and overlap the light incident part of the light guide panel 15 in a K+1^{th} row.

The optical assemblies 10 partially overlap each other to hide the light sources 13, the first part 151, and the side cover 20 from the front side.

As described above, the adjacent optical assemblies 10 of the backlight unit 100 overlap each other to prevent a bright line or a dark line at the boundary of the optical assemblies 10 and improve the uniformity of light.

The upper or lower surface of the light guide panel 15 may be provided with a diffusion pattern (not shown) that has a predetermined pattern to diffuse and reflect incident light, thus improving the uniformity of light at the front surface of the light guide panel 15.

The lower surface of the second part 152 of the light guide panel 15 may be inclined at a predetermined angle, so as to gradually decrease in thickness from an adjacent portion to the first part 151 to a distant portion from the first part 151.

That is, the light emitting part of the light guide panel 15 may include a portion that gradually decreases in thickness from a first side adjacent to the light incident part to a second side distant from the light incident part.

The lower surface of the light guide panel 15 may be provided with the reflecting member 17 that reflects light, laterally incident through the first part 151 and guided in the light guide panel 15, to the upper side. In addition, the reflecting member 17 may prevent interference of light generated between the overlapped optical assemblies 10.

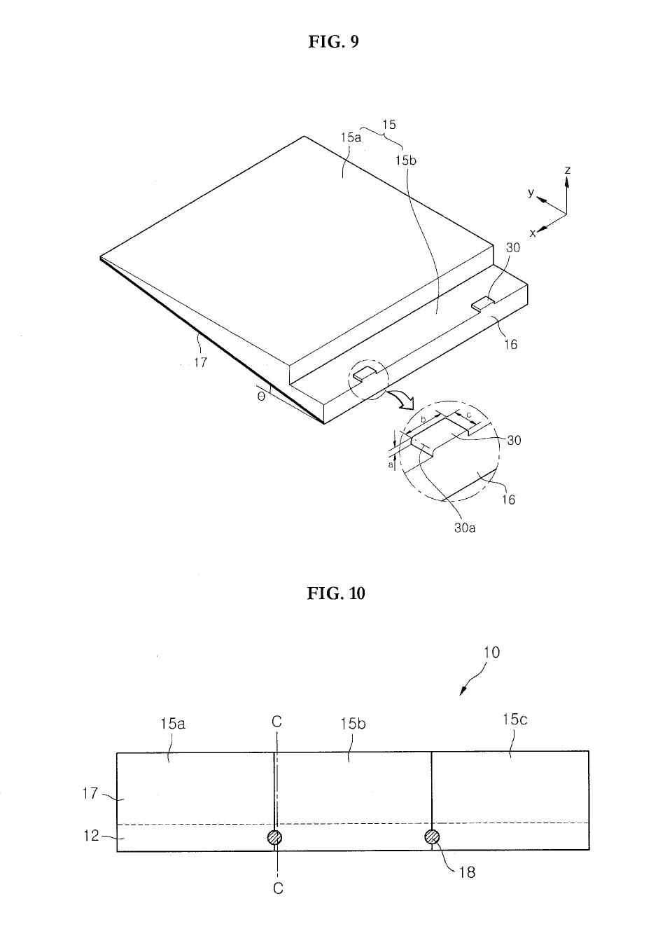

FIG. 9 is a perspective view illustrating the light guide panel 15 of the backlight unit 100. Referring to FIGS. 8 and 9, the light guide panel 15, and particularly, the first part 151 of the light guide panel 15 may include a protrusion 30 protruding with a predetermined height ‘a’. The protrusion 30 may be provided to at least two points in the x-axis direction on the upper surface of the first part 151 of the light guide panel 15.

The shape of the protrusion 30 may be varied. For example, the protrusion 30 may have a rectangular parallelepiped shape. The protrusions 30 are caught by the first side cover 21 to prevent the shaking of the light guide panel 15 along the x-axis and the y-axis.

An edge 30a of the protrusion 30 may be rounded to prevent a case that a crack is formed at the protrusion by shock due to the movement of the light guide panel 15.

The height ‘a’ of the protrusion 30 may range from about 0.3 to 0.6 mm from the upper surface of the first part 151. The protrusion 30 may have a width ‘b’ ranging from about 2 to 5 mm along the x-axis. The protrusion 30 may have a width ‘c’ ranging from about 1 to 3 mm along the y-axis.

The protrusion 30 may be disposed between neighboring LEDs 11 and adjacent to a light incident surface 16 on the upper surface of the first part 151, so as to prevent optical interference of light emitted from the LEDs 11 due to the protrusion 30 integrally formed with the light guide panel 15.

The light sources 13 may include at least one of the LEDs 11, and the module substrate 12 to which the LED 11 is mounted. The LEDs may be arrayed along the x-axis on the module substrate 12 and adjacent to the light incident surface 16 of the first part 151.

The module substrate 12 may include one of a flexible substrate and a printed circuit board (PCB) such as a metal core PCB and a FR-4 PCB, but is not limited thereto. A thermal pad may be disposed under the module substrate 12 between the module substrate 12 and the second side cover 22.

Light emitted from the LEDs 11 is laterally incident to the first part 151. Colors of light incident from the LEDs may be mixed in the light guide panel 15 including the first part 151.

Light emitted from the LEDs is guided in the first part 151 and incident to the second part 152. The light incident to the second part 152 is reflected upward from the reflecting member 17 disposed on the lower surface of the second part 152. At this point, the diffusion pattern disposed on the lower surface of the light guide panel 15 diffuses and spreads the light to improve the uniformity of the light.

The LEDs may be spaced a predetermined distance from each other on the module substrate 12. The LEDs may be disposed in an oblique direction with respect to the protrusion 30 to minimize optical effect due to the protrusion 30 of the light guide panel 15. Accordingly, the distance between the LEDs 11 around the protrusion 30 may be greater than the distance between the other LEDs 11.

The distance between a portion of the LEDs may be greater than the distance between the other LEDs to secure a coupling space of the first side cover 21 and the second side cover 22 and minimize optical effect due to coupling force for pressing the light guide panel 15. For example, when a first distance ‘d’ between the adjacent LEDs 11 is about 10 mm, a second distance ‘e’ of the LEDs 11 around the coupling space may be about 13 mm.

The colors of light emitted from the LEDs 11 are mixed in the light guide panel 15 including the first part 151 to uniformly provide the light to the second part 152.

The side cover 20, surrounding the light sources 13 and a portion of the light guide panel 15, may include the first side cover 21 disposed on the light sources 13 and the first part 151 of the light guide panel 15, and the second side cover 22 disposed under the first part 151. The side cover 20 may be formed of plastic or metal.

The second side cover 22, facing the lower surface of the first part 151, may be bent upward (along the z-axis) at the lower surface of the first part 151 to face the light incident surface 16. A portion 22a of the second side cover 22 may be inclined along the lower surface of the light guide panel 15, that is, along an inclined surface of the light guide panel 15. The second side cover 22 may accommodate the light sources 13.

The first side cover 21 is coupled to the second side cover 22 through a first fixing member 51 to prevent the shaking of the light sources 13 and the light guide panel 15 due to external shock, and particularly, prevent the shaking along the z-axis.

The second side cover 22 supports the inclined surface of the light guide panel 15 to firmly maintain alignment of the light guide panel 15 with the light sources 13 and protect the light guide panel 15 and the light sources 13 from external shock.

The first side cover 21 may have first holes 41 at positions corresponding to the protrusions 30 of the first part 151.

The first holes 41 may be larger than the protrusions 30 such that the protrusions 30 are fitted and caught to the first holes 41. The protrusion 30 disposed in the first hole 41 partially has a predetermined gap that may be a margin for preventing the torsion of the light guide panel 15 when the light guide panel 15 is expanded by environmental change such as sharp temperature increase. In this case, the rest of the protrusion 30 without the predetermined gap may be in contact with the first side cover 21 to increase fixing force thereof.

At least one second hole 42 may be further disposed in the first side cover 21. The second side cover 22 may have at least one third hole 43 at a position corresponding to the second hole 42.

The backlight unit 100 configured as described above may be disposed in the bottom cover 110 having a box shape with an open top.

The bottom cover 110 includes a recess part 111 to which the optical assembly 10 is fixed, and a projection part 112 disposed under the inclined portion of the light guide panel 15 of the optical assembly 10 and protruding from the recess part 111 in the second direction (z-axis direction).

A hole h passes through both the bottom cover 110 and the side cover 20. A cable c extending from a substrate 14 may be connected through the hole h to a driving substrate 250 that is provided to the rear surface of the bottom cover 110.

FIG. 10 is a plan view illustrating the optical assembly 10 according to an embodiment. A structure in which the light guide panels 15a, 15b, and 15c are fixed to the module substrate 12 and the reflecting member 17 will now be described.

Referring to FIG. 10, the light guide panels 15a, 15b, and 15c may be fixed through coupling members 18 to the module substrate 12 and the reflecting member 17 disposed under the light guide panels 15a, 15b, and 15c as illustrated in FIG. 6.

That is, when the number of columns of the light guide panels 15 arrayed in the perpendicular direction to the direction in which light is emitted from the light source 13 is M, an L^{th} one (L is one of 1 to M−1) of the M light guide panels 15 arrayed in the crossing direction the first direction may be coupled to an adjacent L+1^{th} one through the coupling member 18, and fixed to the module substrate 12 and the reflecting member 17 on the lower side through the coupling member 18.

For example, each of the light guide panels 15a, 15b, and 15c may be provided with a hole for receiving the coupling member 18 such as a screw, and the coupling member 18 may be inserted into the hole from the upper side in the state where the light guide panels 15a, 15b, and 15c are placed on the module substrate 12 and the reflecting member 17, so as to fix the light guide panels 15a, 15b, and 15c.

The coupling member 18 may be disposed at the boundary between adjacent two of the light guide panels 15a, 15b, and 15c.

More particularly, an insertion part to which the coupling member 18 is inserted may be disposed in each of the adjacent light guide panels 15b and 15c. For example, one end of the light guide panel 15b may be provided with a first insertion part, and one end of the light guide panel 15c may be provided with a second insertion part.

The coupling member 18 is disposed at a position corresponding to the insertion part to couple adjacent two of the light guide panels 15a, 15b, and 15c.

For example, the coupling member 18 is inserted to the first and second insertion parts to couple the adjacent light guide panels 15b and 15c to each other.

That is, when the number of columns of the light guide panels 15 arrayed in the perpendicular direction to the direction in which light is emitted from the light source 13 is M, the first insertion part is disposed in one end of the L^{th} one (L is one of 1 to M−1) of the M light guide panels 15 arrayed in the crossing direction the first direction, and the second insertion part is disposed in one end of the adjacent L+1^{th} one. In this case, the coupling member 18 is inserted into the first and second insertion parts to couple the L^{th} light guide panel 15 to the L+1^{th} light guide panel 15.

This prevents the case that the coupling member 18 blocks light emitted from the light sources 13 to the light guide panels 15a, 15b, and 15c. Thus, light incident efficiency toward the light guide panels 15a, 15b, and 15c is improved.

A coupling structure of the light guide panel 15b provided to the optical assembly 10 is illustrated in FIG. 10. Thus, the light guide panels 15a and 15c may be also fixed to the module substrate 12 and the reflecting member 17 on the lower side through the coupling members 18 as illustrated in FIG. 10, and coupling positions of the coupling members 18 such as a screw may be varied.

FIG. 11 is a cross-sectional view taken along line C-C of FIG. 10. Referring to FIG. 11, holes for receiving the coupling members 18 such as a screw may be disposed in the light guide panel 15, the reflecting member 17, and the module substrate 12.

The coupling member 18 may include a head part and a protruding part protruding from the head part. For example, the light guide panel 15 may be provided with an insertion part to which the coupling member 18 is inserted. The insertion part may include a seat portion on which the head part of the coupling member 18 is placed, and an insertion portion to which the protruding part is inserted.

In this case, to prevent the head part of the coupling member 18 from protruding out of the upper surface of the light incident part of the light guide panel 15, the head part of the coupling member 18 may have a height that is equal to or less than the depth of the seat portion of the light guide panel 15.

That is, the seat portion provided to the upper surface of the light guide panel 15 to which the coupling member 18 is inserted is recessed with a depth that is equal to or less than the height of the head part of the coupling member 18, so that the head part of the coupling member 18 is disposed in the seat portion.

This prevents the coupling member 18 from protruding out of the light guide panel 15, and thus, the coupling member 18 more firmly fixes the light guide panel 15, the reflecting member 17, and the module substrate 12.

The coupling member 18 may be inserted from the upper side into the light guide panel 15, the reflecting member 17, and the module substrate 12, and then, fixed to the bottom cover 110 on the lower side.

According to the structure of the optical assembly 10 illustrated in FIG. 11, the coupling members 18 fix the light guide panels 15a, 15b, and 15c to the module substrate 12 and the reflecting member 17 on the lower side.

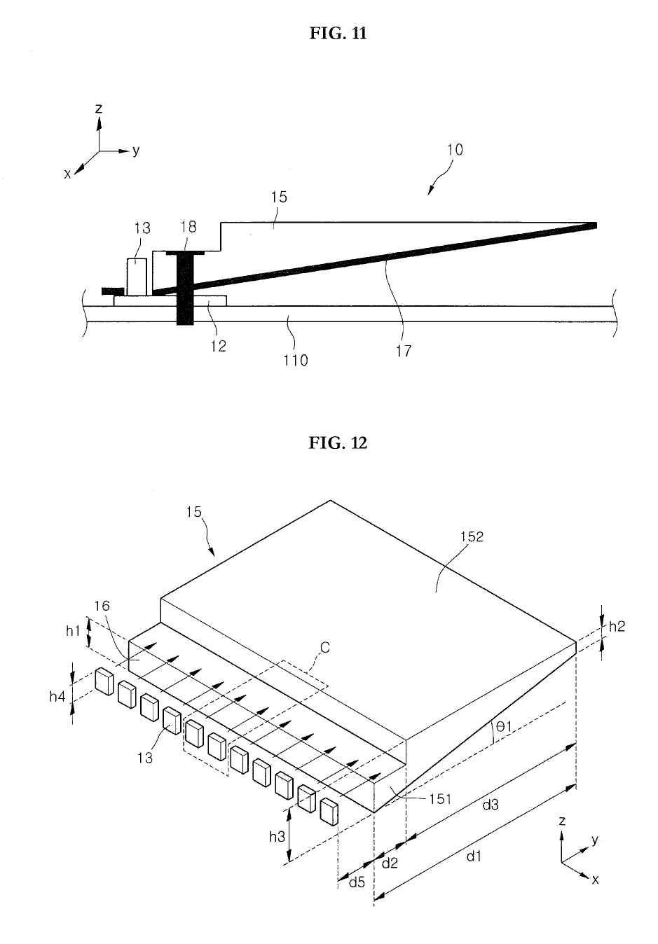

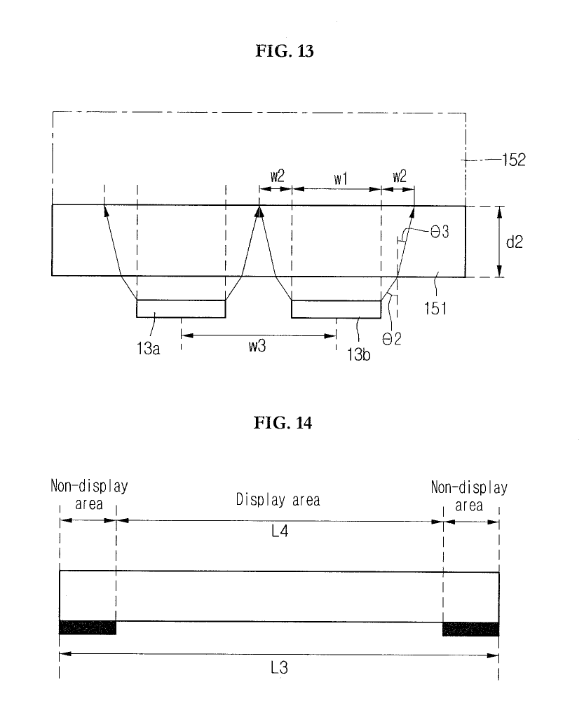

FIG. 12 is a perspective view illustrating the light guide panel 15 and the light sources 13. FIG. 13 is an enlarged plan view illustrating a portion C of FIG. 12. Referring to FIGS. 12 and 13, the light guide panel 15 may include the first part 151 as the light incident part, and the second part 152 as the light emitting part.

Light is incident to a first side of the first part 151 in a first direction (along the y-axis) as a lateral direction. The light sources 13 are arrayed along the light incident surface 16 disposed on the first side of the first part 151.

The light incident surface 16 faces the light sources 13. When the light sources 13 are completely in contact with the light incident surface 16, the light incident surface 16 may be thermally damaged. Thus, the light sources 13 are spaced a predetermined distance d₅ from the light incident surface 16.

When a height of the first side of the first part 151, that is, a height h₁ of light incident surface 16, and a vertical height h₄ of the light sources 13 may satisfy Formula 1:

h₄≦h₁≦2×h₄ (1)

That is, the height h₁ of the light incident surface 16 may be equal to or greater than the height h₄ of the light sources 13, and equal to or less than two times the height h₄ of the light sources 13.

When the height h₁ of the light incident surface 16 is less than the height h₄ of the light sources 13, a portion of light emitted from the light sources 13 to the light incident surface 16 is lost. Thus, the height h₁ of the light incident surface 16 may be equal to or greater than the height h₄ of the light sources 13.

As the height h₁ of the light incident surface 16 is increased, light incident efficiency of the light sources 13 to the light incident surface 16 is increased. However, when the height h₁ of the light incident surface 16 is greater than two times the height h₄ of the light sources 13, the light incident efficiency is converged at a constant value. Thus, according to the current embodiment, the height h₁ of the light incident surface 16 may satisfy Formula 1.

The first part 151 may extend with a predetermined length d₂ from the first side of the first part 151 in the first direction (y-axis direction), so as to change light from the light sources 13, as point light sources, to light emitted from a surface light source.

The length d₂ of the first part 151 in the y-axis direction is determined by factors such as the distance d₅ between the light incident surface 16 and the light sources 13 and a distance between the light sources 13. Hereinafter, the length d₂ of the first part 151 will now be descried in detail.

Referring to FIG. 13, widths of a first light source 13a and a second light source 13b may be w₁, and a width between the centers respectively of the first and second light sources 13a and 13b may be w₃.

That is, the light guide panel 15 is provided with the light sources 13, and a portion of the light sources 13 is selectively lighted according to an external signal. Thus, the light guide panel 15 may be provided with a plurality of sub driving areas.

In this case, light is emitted at a predetermined orientation angle from the first and second light sources 13a and 13b to the outside. The orientation angle of light emitted from the borders of the first and second light sources 13a and 13b is denoted by θ₂.

Since the first and second light sources 13a and 13b are spaced the distance d₅ from the light incident surface 16, an air gap may be disposed between the light incident surface 16 and the first and second light sources 13a and 13b.

Accordingly, when light is incident at the orientation angle θ₂ to the light incident surface 16 from the first and second light sources 13a and 13b, the light may be refracted at a refraction angle θ₃ according to Snell's law.

The orientation angle θ₂ and the refraction angle θ₃ may be expressed as Formula 2.

$${θ}_{3} = {sin}^{- 1} ( \frac{{n}_{1}}{{n}_{2}} sin {θ}_{2} ) \qquad ( 2 )$$

where n₁ denotes the refractive index of air, and n₂ denotes the refractive index of the light guide panel 15.

When light incident to the first part 151 is spread at the refraction angle θ₃, and then, arrives at the boundary between the first part 151 and the second part 152, a width w₄ of the spread light may satisfy Formula 3:

w₄=w₁+2×w₂ (3)

where w₂ denotes a width that is spread left or right from the width w₁ of the first and second light sources 13a and 13b. The width w₂, spread left or right, may satisfy Formula 4:

w₂=d₅ tan θ₂+d₂ tan θ₃≈d₂ tan θ₃ (4)

Since the distance d₅, between the light incident surface 16 and the first and second light sources 13a and 13b, is significantly less than the length d₂ of the first part 151, the width w₂ may be approximately expressed as d₂ tan θ₃. According to the current embodiment, the distance d₅ between the light incident surface 16 and the first and second light sources 13a and 13b may be about 1 mm or less.

Thus, the width w₄ of the spread light may satisfy Formula 5:

w₄=w₁+2d₂ tan θ₃ (5)

In this case, light emitted from the first light source 13a overlaps light emitted from the second light source 13b when they are spread in the first part 151. The boundary of the light emitted from the first light source 13a is at least in contact with the boundary of the light emitted from the second light source 13b, so that light can be uniformly emitted from the second part 152. When light emitted from the first light source 13a and spread in the first part 151 is spaced apart from light emitted from the second light source 13b and spread in the first part 151, light is emitted with a dark line on the second part 152, thus degrading image quality.

Thus, the width w₃ between the centers respectively of the first and second light sources 13a and 13b may satisfy Formula 6:

w₃≦w₁+2d₂ tan θ₃ (6)

That is, the width w₃ between the centers respectively of the first and second light sources 13a and 13b may be the spread width w₄ or less, thus preventing a dark line of the second part 152.

According to Formula 6, the length d₂ of the first part 151 may satisfy Formula 7:

$${d}_{2} \geq \frac{{w}_{3} - {w}_{1}}{2 \times tan {θ}_{3}} = \frac{{w}_{3} - {w}_{1}}{2 \times tan ( {sin}^{- 1} ( \frac{{n}_{1}}{{n}_{2}} sin {θ}_{2} ) )} \qquad ( 7 )$$

That is, the length d₂ should be equal to or greater than a predetermined value to prevent a dark line of the second part 152.

When the length d₂ of the first part 151 is greater than about 20 mm, optical loss may occur. Accordingly, the entire length of the backlight unit 100 may be increased. Thus, according to the current embodiment, the length d₂ of the first part 151 may be about 20 mm or less.

Referring to FIGS. 12 and 13, the second part 152 is disposed on a second side of the first part 151, and emits light, incident to the first part 151, upward, i.e., in a second direction (z-axis direction), so as to provide the light to the display panel 210.

Thus, to emit light in the above manner, the second part 152 may have a predetermined area and extend with a length d₃ in the first direction (y-axis direction), and the length d₂ of the first part 151 and the length d₃ of the second part 152 with respect to the first direction may constitute a length d₁ of the light guide panel 15 in the first direction.

In this case, the length d₃ of the second part 152 may satisfy Formula 8:

$$\frac{{L}_{1}}{50} \leq {d}_{3} \leq \frac{{L}_{1}}{6} \qquad ( 8 )$$

where L₁ denotes a length of the backlight unit 100 in the direction of light emitted from the light sources 13, that is, in a longitudinal direction (y-axis direction).

As described above, the backlight unit 100 may include the 6 to 50 light guide panels 15 arrayed in the direction of light emitted from the light sources 13, that is, in the longitudinal direction.

More particularly, the 4 to 35 light guide panels 15 are disposed on the reflecting member 17 and the module substrate 12 extended in the perpendicular direction to the direction of light emitted from the light sources 13, that is, in the lateral direction (x-axis direction), so as to constitute an optical assembly in a single line, and then this optical assembly is provided to each of 6 to 50 lines that are arrayed in the direction of light emitted from the light sources 13, that is, in the longitudinal direction (y-axis direction), so as to constitute the backlight unit 100.

The length d₂ of the first part 151 and the total length d₁ of the light guide panel 15, i.e., the sum of the length d₂ of the first part 151 and the length d₃ of the second part 152 may satisfy Formula 9:

$$0.03 \leq \frac{{d}_{2}}{{d}_{1}} \leq 0.2 \qquad ( 9 )$$

That is, when the ratio of the length d₂ of the first part 151 to the total length d₁ of the light guide panel 15 is less than 0.03, the length d₂ of the first part 151 may be insufficient, and thus, light emitted from the light sources 13 to the outside may have a point light source shape.

When the ratio of the length d₂ of the first part 151 to the total length d₁ of the light guide panel 15 is greater than 0.2, the length d₂ of the first part 151 is so great as to cause optical loss, and the entire volume of the backlight unit 100 may be increased.

The second part 152 may include the upper surface functioning as a surface light source, the lower surface facing the upper surface, and the four side surfaces.

The lower surface of the light guide panel 15 is inclined upward from the end of the first side of the first part 151 to the end of a second side of the second part 152, and provided with the reflecting member 17 that reflects light, incident through the first part 151, in the second direction. The lower surface of the light guide panel 15 is inclined at an inclined angle θ₁ that may satisfy Formula 10:

$$0 < {θ}_{1} \leq {tan}^{- 1} ( \frac{{h}_{3}}{{d}_{2} + {d}_{3}} sin {θ}_{2} ) \qquad ( 10 )$$

where h₃ denotes the entire height of the light guide panel 15.

That is, the inclined angle θ₁ is greater than 0, and is equal to or less than the maximum of Formula 10.

Referring to FIG. 12, a stair part may be formed by the height difference between the upper surface of the first part 151 and the upper surface of the second part 152.

In this case, the entire height h₃ of the light guide panel 15 may be defined by the sum of the height h₁ of the light incident surface 16 and the height of the stair part.

In this case, when the inclined angle θ₁ is the maximum of Formula 10, a height h₂ of the light guide panel 15 at the end of its second side is converged to 0.

When the ratio of the height h₂ of the light guide panel 15 to the height h₁ of the light incident surface 16 of the light guide panel 15 is a predetermined value or less, the strength of the end of the light guide panel 15 is decreased, and thus, the end of the light guide panel 15 may be broken.

When the ratio of the height h₂ of the light guide panel 15 to the height h₁ of the light incident surface 16 of the light guide panel 15 is greater than 1, light emitting efficiency of light emitted from the second part 152 in the first direction may be reduced.

Thus, the height h₂ of the light guide panel 15 may satisfy Formula 11:

$$0.2 \leq \frac{{h}_{2}}{{h}_{1}} \leq 1.0 \qquad ( 11 )$$

That is, when the ratio h₂/h₁ of the height h₂ of the light guide panel 15 to the height h₁ of the light incident surface 16 ranges from 0.2 to 1.0 according to Formula 11, the strength of the end of the light guide panel 15 is maintained within a predetermined range to prevent the damage of the backlight unit 100 due to an external pressure and improve the efficiency of light emitted from the light sources 13.

The entire height h₃ of the light guide panel 15 and the height h₁ of the light incident surface 16 are different from each other, and may satisfy Formula 12:

$$1.2 \leq \frac{{h}_{3}}{{h}_{1}} \leq 2.5 \qquad ( 12 )$$

That is, when the ratio h₃/h₁ of the entire height h₃ of the light guide panel 15 to the height h₁ of the light incident surface 16 is 1.2 or greater, it is possible to prevent bending of the light guide panel 15 due to stress concentrated on the first part 151 while the light guide panel 15 is formed. In addition, when the ratio h₃/h₁ is 2.5 or less, it is possible to prevent a case that aberration of light due to thickness difference causes a dark area at the front side of the first part 151, that is, at a contact between the first part 151 and the second part 152.

Thus, the ratio h₃/h₁ of the entire height h₃ of the light guide panel 15 to the height h₁ of the light incident surface 16 may range from 1.2 to 2.5 according to the current embodiment.

FIG. 14 is a cross-sectional view taken along line D-D of FIG. 1, which illustrates a front panel 310 provided to the display apparatus 1. Referring to FIG. 14, the front panel 310 is disposed on the front side of the display module 200 to protect the display module 200 from external shock and transmit light emitted from the display module 200, thus displaying an image generated from the display module 200 to the outside.

To this end, the front panel 310 may be formed of glass or plastic such as acryl having an anti-shock property and a light transmittance property.

The front panel 310 may include a display area transmitting light emitted from the display module 200 to display an image, and a non-display area surrounding the display area. A light screening part 320 may be provided to the non-display area to screen light.

The light screening part 320, provided to the non-display area, prevents light from passing through the edges of the display apparatus 1, and hides structures, disposed at the edges of the display apparatus 1, except for an image to be displayed.

The light screening part 320 may be black to effectively screen light, e.g. may include a printed black layer. Accordingly, a user may perceive the non-display area of the display apparatus 1 as black.

The width of the front panel 310, that is, the length of the front panel 310 extended in the lateral direction (x-axis direction) may be L₃. The width of the display area of the front panel 310, that is, the length of the display area of the front panel 310 extended in the lateral direction (x-axis direction) may be L₄.

Referring to FIGS. 6 and 14, the length L₂ of the reflecting member 17 provided with the light guide panels 15a, 15b, and 15c may be equal to or less than the length L₃ of the front panel 310 in the x-axis direction.

As described with reference to FIG. 6, when the optical assemblies 10 each including the single reflecting member 17 are adjacent to each other in the y-axis direction, so as to constitute backlight unit 100, the length L₂ of the reflecting member may be equal to or greater than the length L₄ of the display area of the front panel 310 in the x-axis direction.

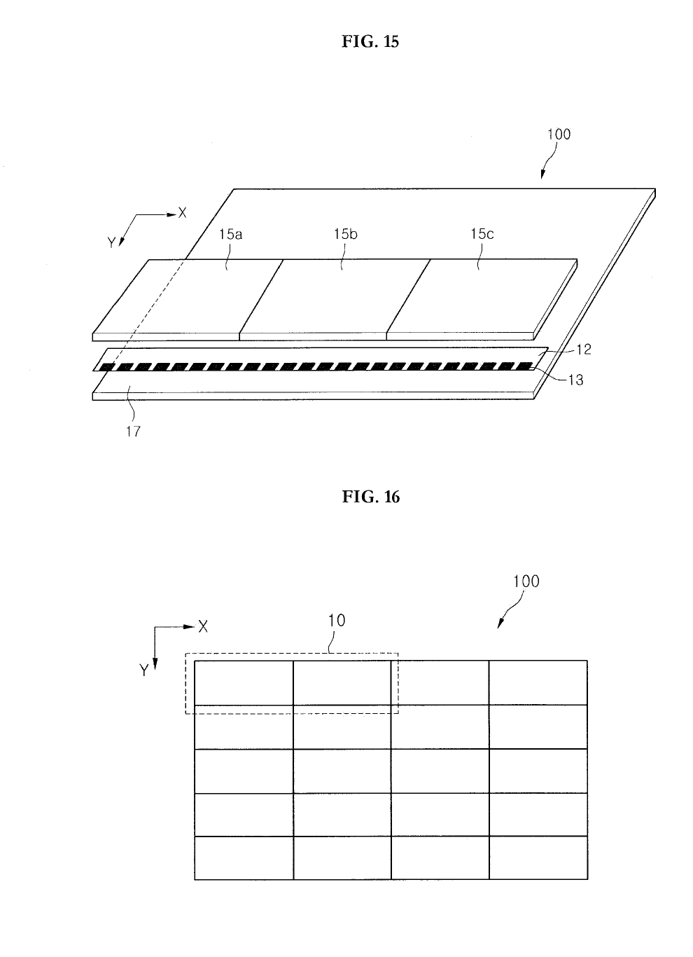

FIG. 15 is a perspective view illustrating the backlight unit 100 according to the embodiment of FIG. 10. A description of the same part as those described with reference to FIGS. 1 to 14 will be omitted.

Referring to FIG. 15, the backlight unit 100 includes the single reflecting member 17, and the light guide panels 15a, 15b, and 15c may be disposed on the reflecting member 17. That is, the module substrate 12 to which the light sources 13 are mounted, and the optical assemblies 10 each including the light guide panels 15a, 15b, and 15c may be disposed on the single reflecting member 17 to constitute the backlight unit 100.

For example, backlight unit 100 as illustrated in FIG. 5 may include the four optical assemblies 10 adjacent to each other in the y-axis direction on single reflecting member 17, and each of the optical assemblies 10 may include light sources 13, the single module substrate 12 to which the light sources are mounted, and the light guide panels 15a-15c.

FIG. 16 is a plan view illustrating the backlight unit 100 according to another embodiment, in which the backlight unit 100 may include the two or more optical assemblies 10 that are adjacent to each other in the x-axis direction.

Referring to FIG. 16, the backlight unit 100 may include twenty light guide panels in a 5×4 matrix with five rows arrayed along the y-axis direction and four columns arrayed along the x-axis direction. The two light guide panels adjacent in the x-axis direction may constitute the single optical assembly 10.

For example, the optical assembly 10 may include a plurality of light sources, a single substrate to which the light sources are mounted, the two light guide panels, and a single reflecting member.

In this case, the backlight unit 100 may include the ten optical assemblies 10 in a 5×2 matrix with five rows arrayed along the y-axis direction and two columns arrayed along the x-axis direction.

The backlight unit 100 of FIG. 16 may include the single reflecting member 17 as described with reference to FIG. 15.

According to the embodiments, the module-type backlight unit including the light guide panels provides light to the display panel. Thus, the thickness of the display apparatus can be decreased, and contrast of a display image can be improved using the entire driving method or the local driving method such as the local dimming method and the impulsive method.

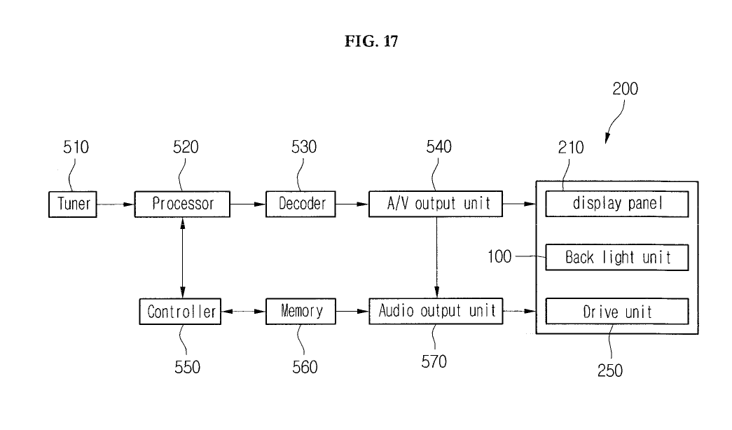

In addition, the backlight unit includes the optical assembly having the light guide panels, thus simplifying a process of manufacturing the backlight unit and the display apparatus. FIG. 17 shows operating elements for a display apparatus according to an embodiment.

Referring to FIG. 9, the display apparatus 1 includes the display module 200, a tuner 510, a processor 520, a decoder 530, an A/V output unit 540, a controller 550, a memory 560, and an audio output unit 570.

A broadcast data stream is transmitted from the tuner 510 through the processor 520, the decoder 530, and the A/V output unit 540 to the display module 200, and is displayed.

An operation of the tuner 510 or the processor 520 may be controlled by the controller 550 that may include the memory 560.

When the display apparatus 1 configured as described above is operated to select an arbitrary channel, the controller 550 controls the tuner 510 and the processor 520 to select the channel, and the processor 520 divides a data stream of a broadcast program, provided through the channel, into an audio data and a video data, and outputs them.

Then, the decoder 530 decodes the audio data and the video data output from the processor 520 into an audio signal and a video signal, so that the audio signal and the video signal can be output through the A/V output unit 540 to the display module 200 or the audio output unit 570 such as a speaker unit. A driving unit 250 drives the backlight unit 100 to display the output video signal on the display panel 210. A broadcast data stream transmitted to the processor 520 may be provided through the Internet.

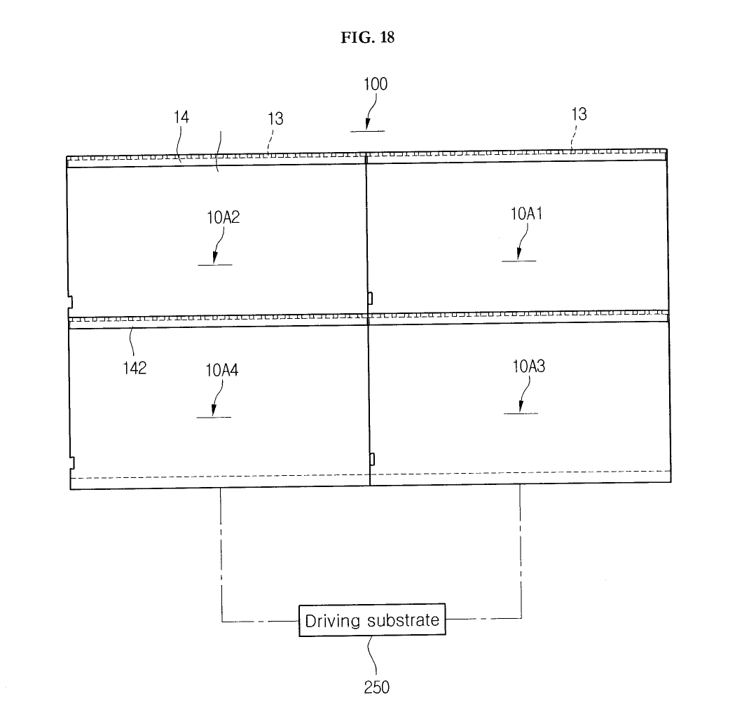

FIG. 18 shows operating elements for a back light unit according to an embodiment. Referring to FIG. 18, a plurality of optical assemblies 10A1, 10A2, 10A3, 10A4, each of which includes the light guide panel 15 and the reflecting member 17, are arrayed to form the backlight unit 100.

That is, the circuit substrates 14 and the light sources 13 are disposed on one side or two sides of the light guide panel, and the optical assemblies 10A1, 10A2, 10A3, 10A4 including the light guide panels 15 and the reflecting members 17 are arrayed on the light guide parts 110, so as to constitute the backlight unit 100.

The backlight unit 100 fabricated by coupling the optical assemblies 10A1, 10A2, 10A3, 10A4 as described above, or the light sources 13 connected to the backlight unit 100 may be independently or divisionally driven in group units by the driving substrate 250, thus significantly reducing power consumption of the backlight unit 100.

In this case, the division driving may be set and performed in module units, in light source units of the light sources 13, or in light source set units that are logically grouped.

That is, the light sources 13 may be grouped into primary light source groups that constitute sides respectively of modules, so that the light sources 13 can be driven in primary group units. Alternatively, the light sources 13 may be grouped into sub groups of the light sources 13 that constitute sides respectively of modules, so that the light sources 13 can be driven in sub group units.

As described above, according to the current embodiment, the light guide panels 15 are minimized, and the light sources 13 are continuously attached to the side surfaces of the light guide panels 15, thus securing a predetermined amount of light and dissipating heat. Specifically, the light sources 13 attached to the side surfaces of the light guide panels 15 are optically hidden.

According to the embodiment of FIG. 1, the small light guide panels are continuously attached to each other in light guide module manner to constitute the entire area of the display. Thus, the light sources can be disposed between the light guide panels, and the identical light guide panels can be used regardless of the size of the display.

The light guide panels are provided in module form, and continuously attached in tile manner, so as to form a large screen. Thus, identical parts can be applied to various sizes of televisions by varying the number thereof, so that the parts can be standardized.

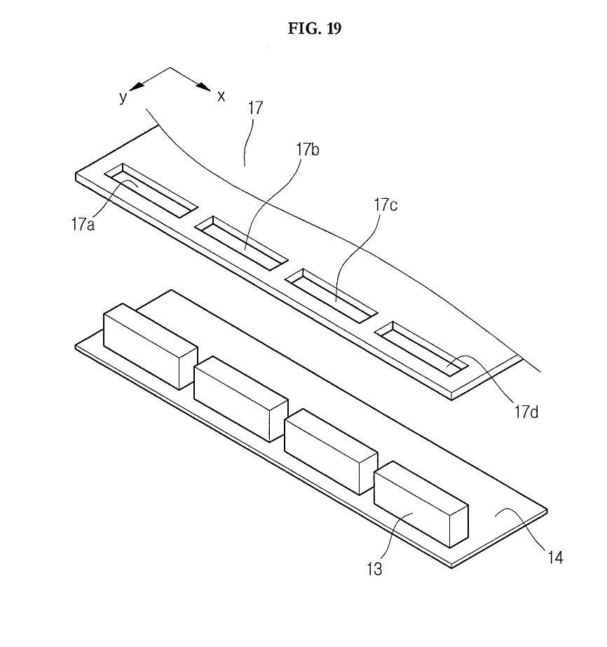

FIG. 19 is a perspective view illustrating a reflecting element and a substrate according to an embodiment. Referring to FIG. 19, at least one portion of the reflecting member 17 of the optical assembly 10 is placed on the substrate 14. The portion of the reflecting member 17 placed on the substrate 14 is provided with holes 17a, 17b, 17c, and 17d through which the light sources 13 arrayed on the substrate 14 pass.

In more detail, the holes 17a, 17b, 17c, and 17d have shapes and sizes corresponding to the light sources 13, and disposed at positions corresponding to the light sources 13.

Thus, when assembling the optical assembly 10, the light sources 13 are inserted into the holes 17a, 17b, 17c, and 17d of the reflecting member 17, so that the position of the reflecting member 17 relative to the substrate 14 can be fixed.

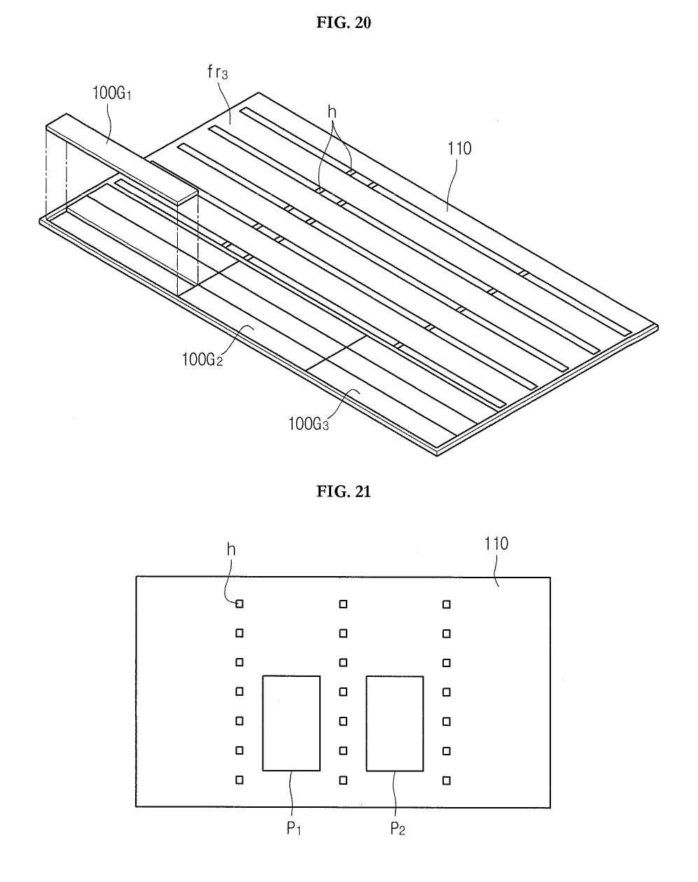

FIG. 20 is a perspective view illustrating a backlight unit according to an embodiment, and FIG. 21 is a plan view of a rear surface of a bottom cover of FIG. 20. The current embodiment is the same as the embodiment of FIG. 1 except for a bottom cover and an optical assembly, which will be described in detail.

Referring to FIGS. 20 and 21, a plurality of optical assemblies 100G1, 100G2, and 100G3 are arrayed in three lines on the bottom cover 110 of the backlight unit 100. A plurality of holes h are disposed in the bottom cover 110 to connect connection parts 148 provided to the rear surfaces of the substrates 14 respectively of the optical assemblies 100G1, 100G2, and 100G3 to driving substrates P1 and P2 provided to the rear surface of the bottom cover 110.

In more detail, the optical assemblies 100G1, 100G2, and 100G3 are arrayed in one to three lines on the bottom cover 110. The connection parts 148 of the substrates 14 may be directly disposed on the bottom cover 110 in correspondence with the line or the lines, or the holes h for connecting the connection parts 148 to the driving substrates P1 and P2 may be disposed in the bottom cover 110 in correspondence with the line or the lines.

The driving substrates P1 and P2 are provided to the rear surface of the bottom cover 110, and may be referred to as a first driving substrate and a second substrate, respectively. The first driving substrate P1 is disposed between neighboring first and second lines of the three lines, and the second driving substrate P2 is disposed between neighboring second and third lines of the three lines. Hereinafter, a configuration of the substrate 14 of the optical assembly 10 will now be described in detail.

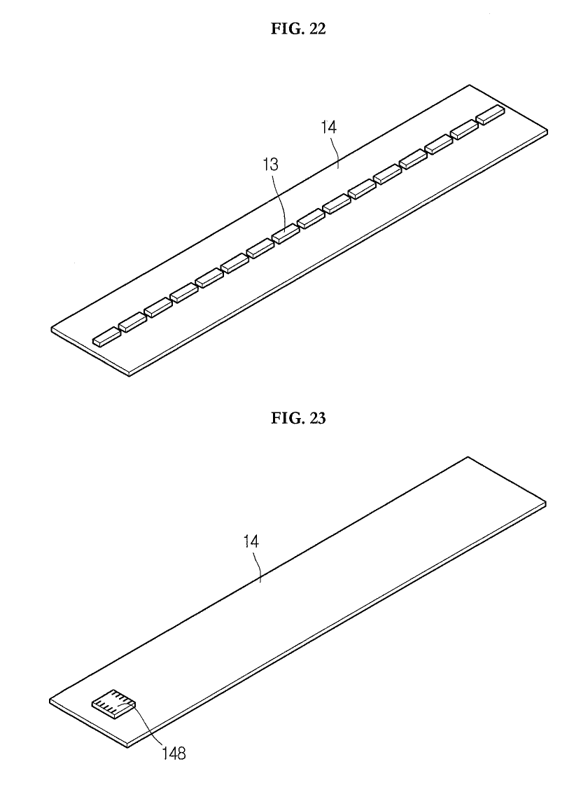

FIG. 22 is a perspective view of a substrate of an optical unit of FIG. 20, and FIG. 23 is a perspective view of a rear surface of the substrate of FIG. 22.

Referring to FIGS. 22 and 23, the light sources 13 are disposed on a surface of the substrate 14, and the connection part 148 is disposed on an inner surface of the substrate 14 facing the bottom cover 110.

The connection part 148 is connected with a cable member (not shown) for transmitting a control signal from the driving substrates P1 and P2, and protrudes from the inner surface of the substrate 14 to the bottom cover 110.

The connection part 148 may directly pass through the hole h provided to the bottom cover 110.

The cable member has a side connected to the connection part 148, and another side connected to the driving substrates P1 and P2, to transmit the control signal of the driving substrates P1 and P2 through the connection part 148 to the substrate 14 and the light sources 13.

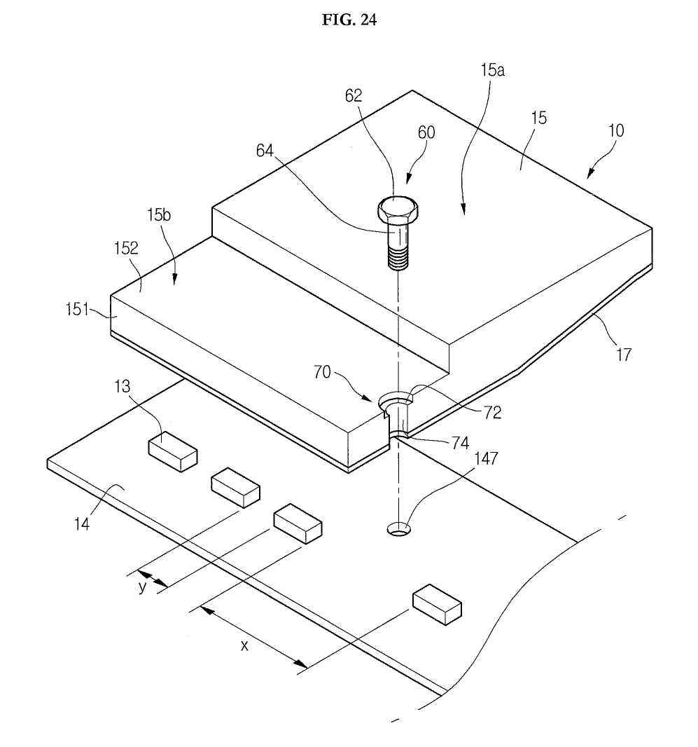

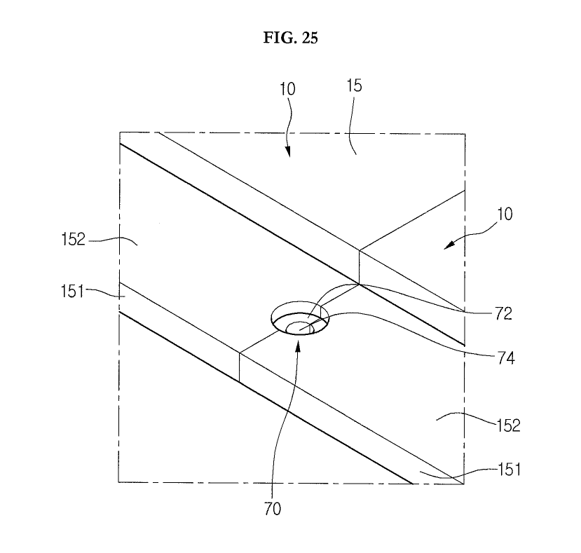

FIG. 24 is an exploded perspective view of an optical assembly according to an embodiment, and FIG. 25 is a perspective view of two light guide panels that are aligned of FIG. 16.

The current embodiment is the same as the embodiment of FIG. 1 except for a fixing structure of a light guide panel, which will now be described in detail.

Referring to FIGS. 24 and 25, the light incident part 15b of the light guide panel 15 of the optical assembly 10 is provided with a fixing part 70 where a fixing member 60, for fixing the light guide panel 15 to the substrate 14 or the bottom cover 110, is disposed.

The fixing part 70 of one of the adjacent light guide panels 15 is in contact with the fixing part 70 of the other to have a shape corresponding to the entire shape of the fixing member 60.

The fixing part 70 includes a recess part 72 that is disposed in the upper surface 152 of the light incident part 15b, and a through part 74 that passes through the lower side of the recess part 72. The recess part 72 is recessed with a diameter and a thickness corresponding to a head part 62 of the fixing member 60. A fixing member body 64 of the fixing member 60 having a spiral is inserted and fixed to the through part 74.

The substrate 14 is provided with a fixing hole 147 that is disposed at a position corresponding to the through part 74 to fix at least one portion of the fixing member body 64 passing through the through part 74. A distance x between the light sources 13 at a portion where the fixing hole 147 is disposed is greater than a distance y between the light sources 13 at a portion without the fixing hole 147 to prevent optical interference due to the fixing member 60.

Thus, when the light guide panels 15 of the backlight unit 100 are adjacent to each other, the fixing member body 64 passes through the through part 74 and is fixed to the substrate 14 or the bottom cover 110, and the head part 62 provided to the side of the fixing member body 64 compresses the recess part 72 to the substrate 14 or the bottom cover 110, thus fixing the light guide panels 15 to the substrate 14 or the bottom cover 110.

Although the configurations according to the aforementioned embodiments are provided independently, they may be combined to each other.

The embodiments described herein, therefore, provide a backlight unit and a display apparatus including the backlight unit, which improve the quality of a display image.

In one embodiment, a backlight unit includes a substrate; a plurality of light sources on the substrate, the light sources emitting light with a predetermined orientation angle with respect to a first direction; a plurality of light guide panels each including: a light incident part having a light incident surface to light from the light source is laterally incident; and a light emitting part emitting the incident light upward; and a reflecting member under the light guide panels, wherein two or more of the light guide panels are disposed on the single reflecting member, and the light emitting part of the light guide panel includes a portion that gradually decreases in thickness from a side adjacent to the light incident part to a side distant from the light incident part.

In another embodiment, a backlight unit includes one or more substrates; a plurality of light sources on the substrate, the light sources emitting light with a predetermined orientation angle with respect to a first direction; a plurality of light guide panels each including: a light incident part having a light incident surface to light from the light source is laterally incident; and a light emitting part emitting the incident light upward; and a reflecting member under the light guide panels, wherein the light guide panels comprise N (N is 2 or greater) light guide panels arrayed in the first direction, and M (M is 2 or greater) light guide panels arrayed in a direction crossing the first direction, at least one portion of the light emitting part of a K^{th} (K is one of 1 to N−1) light guide panel of the N light guide panels arrayed in the first direction is disposed on an upper side of the light incident part of a K+1^{th} light guide panel, and a coupling member is disposed in a first insertion part disposed in an L^{th} (L is one of 1 to M−1) light guide panel of the M light guide panels and in a second insertion part disposed in an L+1^{th} light guide panel.

In further another embodiment, a display apparatus includes: a backlight unit divided into a plurality of blocks and dividedly drivable in a block unit; and a display panel on an upper side of the backlight unit, wherein the backlight unit includes: a substrate; a plurality of light sources on the substrate, the light sources emitting light with a predetermined orientation angle with respect to a first direction; a plurality of light guide panels each including: a light incident part having a light incident surface to light from the light source is laterally incident; and a light emitting part emitting the incident light upward; and a reflecting member under the light guide panels, wherein two or more of the light guide panels are disposed on the single reflecting member, and the light emitting part of the light guide panel includes a portion that gradually decreases in thickness from a side adjacent to the light incident part to a side distant from the light incident part.

A display apparatus comprises a display panel; a frame; a backlight unit I having a plurality of light guide panels provided between the display panel and the frame; and a drive circuit provided adjacent to the frame, wherein the plurality of light guide panels are divided into a plurality of division driving areas, wherein the light guide panels in at least one division driving area emit light independently from the light guide panels in at least one other division driving areas such that a brightness of the at least one division driving area is different from brightness of the at least one other division driving areas.

A backlight unit comprises: a plurality of light guide panels, at least one light guide panel having a light incident to receive light from a first direction and a light emitting section adjacent to the light incident section to emit light received from the light incident section in a second direction, the first and second directions being different directions; a plurality of light sources, the incident section of at least one light guide panel being adjacent to at least one light source to receive the light; and a reflecting member adjacent the at least one light guide panel, wherein the light emitting section of the at least one light guide panel includes a section that decreases in thickness from a first point to a second point, wherein the first point is closer to the light incident section than the second point.

A backlight unit comprises: a plurality of light guide panels, at least one light guide panel having a light incident to receive light from a first direction and a light emitting section adjacent to the light incident section to emit light received from the light incident section in a second direction, the first and second directions being different directions, the plurality of light guide panels are arranged in an N×M matrix, where N is in the first direction and M is in the second direction; a plurality of light sources, the incident section of at least one light guide panel being adjacent to at least one light source to receive the light; and a reflecting member adjacent the light guide panels, wherein at least a portion of the light emitting section of a K^{th} (K is one of 1 to N−1) light guide panel overlaps a portion of the light incident section of a K+1^{th} light guide panel.

The present disclosure also provides a “green” technology for display devices. Presently, the backlight is generally turned on continuously, even when the display of the entire screen is not desirable. For example, the prior art display allows control of the resolution of the entire display screen but not the size of the display screen. However, in certain instances, a smaller screen area may be desirable for lower resolution images. The size of the display area can be controlled based on the present disclosure. For example, instead of viewing images and programs in 42 inch display, the display screen size can be reduce to 32 inches by turning off the light sources for appropriate number of light guide plates located at the periphery of the display device. As can be appreciated, the location and size of the display area can be controlled based on program or user needs. As can be appreciated, multiple configuration may be possible based on turning on or off the light sources for appropriate number of light guide plates (light guide panels or light guide modules or assemblies) based on application and user configuration.

This application is related to Korean Applications Nos. 10-2008-0049146 filed on May 27, 2008, 10-2008-0061487 filed on Jun. 27, 2008, 10-2008-0099569 filed on Oct. 10, 2008, 10-2009-0035029 filed on Apr. 22, 2009 10-2009-0036472 filed Apr. 27, 2009, 10-2009-0052805 filed on Jun. 15, 2009, 10-2009-0061219 filed Jul. 6, 2009, 10-2009-0071111 filed Aug. 2, 2009, 10-2009-0072449 filed Aug. 6, 2009, 10-2009-0080654 filed Aug. 28, 2009, 10-2009-0098844 filed on Oct. 16, 2009, and 10-2009-0098901 filed on Oct. 16, 2009, whose entire disclosures are incorporated herein by reference. Further, this application is related to U.S. Provisional Patent Application Nos. 61/219,480 filed on Jun. 23, 2009; 61/229,854 filed on Jul. 30, 2009; 61/230,844 filed on Aug. 3, 2009; and 61/237,841 filed on Aug. 28, 2009 and U.S. application Ser. Nos. 12/453,885 filed on May 22, 2009, 12/618,603 filed on Nov. 13, 2009, 12/632,694 filed on Dec. 7, 2009, and LGE-162, LGE-163, HI-0400, HI-0412, HI-0413, HI416 and HI-0420 all filed on Mar. 19, 2010, whose entire disclosures are incorporated herein by reference.

It will be apparent to those skilled in the art that various modifications and variations can be made in the present disclosure without departing from the spirit or scope of the present disclosure. Thus, it is intended that the present disclosure cover the modifications and variations of this present disclosure provided they come within the scope of the appended claims and their equivalents.

Any reference in this specification to “one embodiment,” “an embodiment,” “example embodiment,” etc., means that a particular feature, structure, or characteristic described in connection with the embodiment is included in at least one embodiment of the disclosure. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A backlight unit comprising:
a plurality of light guide panels, at least one light guide panel having a light incident to receive light from a first direction and a light emitting section adjacent to the light incident section to emit light received from the light incident section in a second direction, the first and second directions being different directions;
a plurality of light sources, the incident section of at least one light guide panel being adjacent to at least one light source to receive the light; and
a reflecting member adjacent the at least one light guide panel, wherein the light emitting section of the at least one light guide panel includes a section that decreases in thickness from a first point to a second point, wherein the first point is closer to the light incident section than the second point.

2. The backlight unit of claim 1, wherein the reflecting member is coupled to a surface of one or more of the light guide panels.

3. The backlight unit of claim 1, wherein with the light incident section of the at least one light guide panel includes a first insertion part and the light incident section of an adjacent light guide panel to the at least one light guide panel in the second direction includes a second insertion part.

4. The backlight unit of claim 3, further comprising:
a coupling member to couple the at least one light guide panel and the adjacent light guide panel to each other.

5. The backlight unit of claim 4, wherein the coupling member is coupled to the first insertion part of the at least one light guide panel and the second insertion part of the adjacent light guide panel.

6. The backlight unit of claim 4, wherein the coupling member fixes a position the at least one light guide panel and the adjacent light guide panel to each other.

7. The backlight unit of claim 4, wherein the coupling member comprises a head part and a protruding part protruding from the head part.

8. The backlight unit of claim 7, wherein the first and second insertion parts comprises: a seat portion on which the head part of the coupling member is placed and an insertion portion to which the protruding part of the coupling member is inserted.

9. The backlight unit of claim 8, wherein the head part has a height that is substantially equal to or less than a depth of the seat portion.

10. The backlight unit of claim 1, further comprising:
a first cover to cover at least the light sources.

11. The backlight unit of claim 1, wherein a portion of the light emitting part of the at least one light guide panel overlaps a portion of the light incident part of an adjacent light guide panel in the first direction.

12. The backlight unit of claim 1, wherein the light guide panel has a length d₁ in the first direction, the light incident part has a length d₂ in the first direction, and the lengths d₁ and d₂ satisfy the following:
$$0.03 \leq \frac{{d}_{2}}{{d}_{1}} \leq 0.2$$

13. The backlight unit of claim 1, wherein the light guide panel has a lower surface inclined at an angle θ₁, and wherein an entire height h₃ of the light guide panel, a length d₂ of the light incident section in the first direction, and a length d₃ of the light emitting section in the first direction satisfy the following:
$$0 < {θ}_{1} \leq {tan}^{- 1} ( \frac{{h}_{3}}{{d}_{2} + {d}_{3}} sin {θ}_{2} )$$

14. The backlight unit of claim 1, wherein a section of the light incident section closest to the light source has a height h₁, and a section of the light emitting section farthest from the light incident section has a height h₂, wherein the heights h₁ and t h₂ satisfies the following:
$$0.2 \leq \frac{{h}_{2}}{{h}_{1}} \leq 1.0 .$$

15. The backlight unit of claim 1, wherein t a difference in height between the light incident section and the light emitting section results in an elevated structure having a prescribed height, and the light incident section has a height h₁, and a height h₃, which is a sum of the height of the light incident section and the prescribed height of the elevated structure, satisfy the following:
$$1.2 \leq \frac{{h}_{3}}{{h}_{1}} \leq 2.5 .$$

16. A backlight unit comprising:
a plurality of light guide panels, at least one light guide panel having a light incident to receive light from a first direction and a light emitting section adjacent to the light incident section to emit light received from the light incident section in a second direction, the first and second directions being different directions, the plurality of light guide panels are arranged in an N×M matrix, where N is in the first direction and M is in the second direction;
a plurality of light sources, the incident section of at least one light guide panel being adjacent to at least one light source to receive the light; and
a reflecting member adjacent the light guide panels, wherein at least a portion of the light emitting section of a K^{th} (K is one of 1 to N−1) light guide panel overlaps a portion of the light incident section of a K+1^{th} light guide panel.

17. The backlight unit of claim 16, wherein two or more light guide panels of the M light guide panels are disposed over the reflecting member.

18. The backlight unit of claim 16, wherein two or more light guide panels of the N light guide panels are disposed over the reflecting member.

19. The backlight unit of claim 16, further comprising:
a coupling member disposed in a first insertion part disposed in an L^{th} (L is one of 1 to M−1) light guide panel of the M light guide panels and in a second insertion part disposed in an L+1^{th} light guide panel.

20. A display apparatus comprising:
a display panel;
a frame;
a backlight unit I having a plurality of light guide panels provided between the display panel and the frame; and
a drive circuit provided adjacent to the frame, wherein the plurality of light guide panels are divided into a plurality of division driving areas, wherein the light guide panels in at least one division driving area emit light independently from the light guide panels in at least one other division driving areas such that a brightness of the at least one division driving area is different from brightness of the at least one other division driving areas.
